(19) United States
(12) Patent Application Publication
(10) Pub. No.: US 2015/0113387 A1
(43) Pub. Date: Apr. 23, 2015

(54) METHOD FOR DOCUMENT CORRECTION AND ELECTRONIC DEVICE THEREOF

(71) Applicant: Samsung Electronics Co., Ltd., Gyeonggi-do (KR)

(72) Inventors: Hee-Jin Kim, Seoul (KR); Kyung-Hwa Kim, Seoul (KR); Seon-Hwa Kim, Seoul (KR); Mi-Jung Park, Gyeonggi-do (KR); Jo-Ah Choi, Seoul (KR)

(21) Appl. No.: 14/517,756

(22) Filed: Oct. 17, 2014

(30) Foreign Application Priority Data
Oct. 17, 2013 (KR) 10-2013-0124067

(51) Int. Cl. G06F 17/21; G06K 9/00

(52) U.S. Cl. CPC G06F 17/212; G06K 9/00463
USPC 715/247; 715/249

(57) ABSTRACT

A method and apparatus for correcting a document in an electronic device are provided. The method for correcting the document in the electronic device includes the operations of correcting a slope of a document based on a slope of at least one character included in the document, changing a form of the document of which the slope is corrected, and deciding the document of a normal direction.

### PRIORITY

The present application is related to and claims priority under 35 U.S.C. §119(a) to a Korean Patent Application filed in the Korean Intellectual Property Office on Oct. 17, 2013 and assigned Serial No. 10-2013-0124067, the contents of which are herein incorporated by reference.

### TECHNICAL FIELD

The present disclosure relates to a method for a document correction and an electronic device thereof.

### BACKGROUND

With the development of Information Telecommunication (IT) technologies and semiconductor technologies, a variety of kinds of electronic devices are evolving into multimedia devices providing various multimedia services. For example, a portable electronic device can provide various multimedia services such as a broadcasting service, a wireless Internet service, a music playback service, and the like.

### SUMMARY

If an electronic device user photographs a document with a camera of an electronic device, the photographed document has a direction value corresponding to a slope value of the electronic device. That is, if a forward direction of the document is an up-to-down direction but the slope value of the electronic device is a left-to-right direction at a time when the user photographs the document with the camera, the direction of the document photographed with the camera is converted into the left-to-right direction. Accordingly, to use the photographed document as the document of the normal direction, the electronic device performs an additional operation of rotating the document.

To address the above-discussed deficiencies, it is a primary object to provide an apparatus and method for correcting a slope of a document using at least one character comprised in the document, changing a form of the document, and deciding the document of a normal direction in an electronic device.

In a first example an apparatus is provided. The apparatus is configured to, if a plurality of characters in a document is recognized, correct a slope of the document into an average slope of the plurality of characters in an electronic device.

In a second example, a method is provided. The method includes if a plurality of characters in a document is recognized, correcting a slop of the document into an average slope of the plurality of characters in an electronic device.

In a third example, an apparatus is provided. The apparatus is configured to, if a plurality of characters in a document is recognized, correct a slope of the document into a slope of the largest number among slopes of the plurality of characters in an electronic device.

In a third example, a method is provided. The method includes if a plurality of characters in a document is recognized, correcting a slope of the document into a slope of the largest number among slopes of the plurality of characters in an electronic device.

In a forth example, an apparatus is provided. The apparatus is configured to determine if a recognized character is in a normal direction. The apparatus is also configured to decide the document as the document of the normal direction in an electronic device if the recognized character is a character of the normal direction.

In a fifth example, a method is provided. The method includes determining if a recognized character is in a normal direction. The method also includes deciding the document as the document of the normal direction in an electronic device if the recognized character is a character of the normal direction.

In a sixth example, an apparatus is provided. The apparatus is configured to determine if a recognized character is in a normal direction through a comparison between a character original database comprising character information of the normal direction and the character in an electronic device.

In a seventh example, a method is provided. The method includes determining if a recognized character is in a normal direction through a comparison between a character original database comprising character information of the normal direction and the character in an electronic device.

In an eighth example, an apparatus is provided. The apparatus is configured to rotate a document by a reference angle in a reference direction. The apparatus is also configured to decide the document of a normal direction in an electronic device.

In a ninth example, a method is provided. The method includes rotating a document by a reference angle in a reference direction. The method also includes deciding the document of a normal direction in an electronic device.

In a tenth example, an apparatus is provided. The apparatus is configured to invert a document left/right or up/down. The apparatus is also configured to decide the document of a normal direction in an electronic device.

In an eleventh example, a method is provided. The method includes invert a document left/right or up/down. The method also includes deciding the document of a normal direction in an electronic device.

In a twelfth example, an apparatus is provided. The apparatus is configured to decide an edge of a document using a plurality of characters comprised in the document in an electronic device.

In a thirteenth example, a method is provided. The method includes deciding an edge of a document using a plurality of characters comprised in the document in an electronic device.

In a fourteenth example, an apparatus is provided. for the apparatus is configured to decide an edge of a document based on region setting for the document in an electronic device.

In a fifteenth example, a method is provided. The method includes deciding an edge of a document based on region setting for the document in an electronic device.

In a sixteenth example, an apparatus is provided. The apparatus is configured to reset the region to comprise the non-included text in an electronic device when a non-included text exits at the left/right of a set region.

In a seventeenth example, a method is provided. The method includes resetting the region to comprise the non-included text in an electronic device when a non-included text exits at the left/right of a set region.

In an eighteenth example, an apparatus is provided. The apparatus is configured to magnify and display a document to comprise all of the content of the decided document in an electronic device.

In a nineteenth example, a method is provided. The method includes magnifying and displaying a document to comprise all of the content of the decided document in an electronic device.

In a twentieth example, a method for correcting a document in an electronic device is provided. The method includes correcting a slope of a document using at least one character comprised in the document. The method also includes changing a form of the document of which the slope is corrected. The method further includes deciding the document of a normal direction.

In a twenty-first example, an electronic device is provided. The electronic device includes a memory. The electronic device also includes a display. The electronic device further includes at least one processor. The at least one processor is configured to control to correct a slope of a document using at least one character comprised in the document. The at least one processor is also configured to change a form of the document of which the slope is corrected. The at least one processor is further configured to decide the document of a normal direction.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a construction of an example electronic device according to this disclosure;

FIG. 2 is a block diagram illustrating a detailed construction of an example processor according to this disclosure;

FIG. 3 is a flowchart illustrating an example procedure for deciding a document of a normal direction in an electronic device according to this disclosure;

FIG. 4 is a flowchart illustrating an example procedure for deciding a document of a normal direction in an electronic device according to this disclosure;

FIGS. 5A, 5B, 5C, 5D, 5E and 5F illustrate example screen constructions for deciding a document of a normal direction in an electronic device according to this disclosure;

FIG. 6 is a flowchart illustrating an example procedure for deciding a document of a normal direction in an electronic device according to this disclosure;

FIGS. 7A, 7B, 7C, 7D, 7E, 7F, 7G, 7H, 7I, 7J and 7K illustrate example screen constructions for deciding a document of a normal direction in an electronic device according to this disclosure;

FIG. 8 illustrates an example screen construction for deciding an edge of a document in an electronic device according to this disclosure;

FIGS. 9A and 9B illustrate example screen constructions for deciding a region in a document in an electronic device according to this disclosure; and

FIGS. 10A and 10B illustrate example screen constructions for magnifying and displaying a document in an electronic device according to this disclosure.

### DETAILED DESCRIPTION

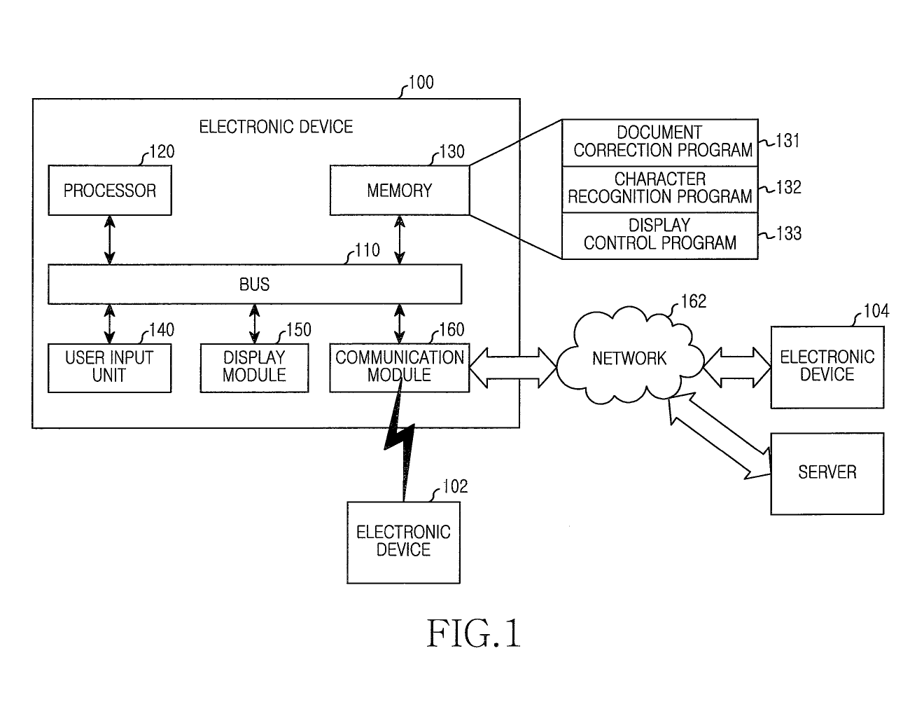

FIGS. 1 through 10B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Various exemplary embodiments of the present disclosure are described below with reference to the accompanying drawings. The various exemplary embodiments of the present disclosure exemplify specific exemplary embodiments in the drawings and state a related detailed description, but can make various modifications and can have several exemplary embodiments. Accordingly, it should be understood that the various exemplary embodiments of the present disclosure do not intend to be limited to a specific embodiment form, and include all modifications or equivalents or substitutes included in the spirit and technological scope of the various exemplary embodiments of the present disclosure. In relation to a description of the drawing, like reference symbols denote like constituent elements.

An electronic device can be one or a combination of various electronic devices including a smart phone, a tablet personal computer (PC), a mobile phone, a video phone, an electronic book (e-book) reader, a desktop PC, a laptop PC, a netbook computer, a personal digital assistant (PDA), a portable multimedia player (PMP), an MPEG Audio Layer 3 (MP3) player, a mobile medical instrument, an electronic bracelet, an electronic necklace, an electronic accessory, a camera, a wearable device, an electronic clock, a wrist watch, a smart home appliance (such as a refrigerator, an air conditioner, a cleaner, an artificial intelligence robot, a TV, a digital video disk (DVD) player, an audio system, an oven, a microwave, a washing machine, an air cleaner, and an electronic frame), various medical instruments (such as magnetic resonance angiography (MRA), magnetic resonance imaging (MRI), computerized tomography (CT), a moving-camera, and an ultrasound machine), a navigation device, a global positioning system (GPS) receiver, an event data recorder (EDR), a flight data recorder (FDR), a set-top box, a TV box (for example, Samsung HomeSync™, Apple TV™, or Google TV™), an electronic dictionary, a car infotainment device, an electronic equipment for ship (such as a navigation device for ship and a gyrocompass), avionics, a security instrument, electronic clothes, an electronic locking system, a camcorder, a game console, a head-mounted display (HMD), a flat panel display device, an electronic album, part of a furniture or building/structure including a telecommunication function, an electronic board, an electronic signature receiving device, or a projector. It is apparent to those skilled in the art that the electronic device according to this disclosure is not limited to the aforementioned instruments.

FIG. 1 is a block diagram illustrating a construction of an example electronic device according to this disclosure.

Referring to FIG. 1, the electronic device 100 includes a bus 110, a processor 120, a memory 130, a user input module 140, a display module 150, a communication module 160, or a camera.

The bus 110 is a circuit connecting the constituent elements (such as the bus 110, the processor 120, the memory 130, the user input module 140, the display module 150, the communication module 160 or the camera) included in the electronic device 100 with one another, and relaying communication (such as control message) between the aforementioned constituent elements.

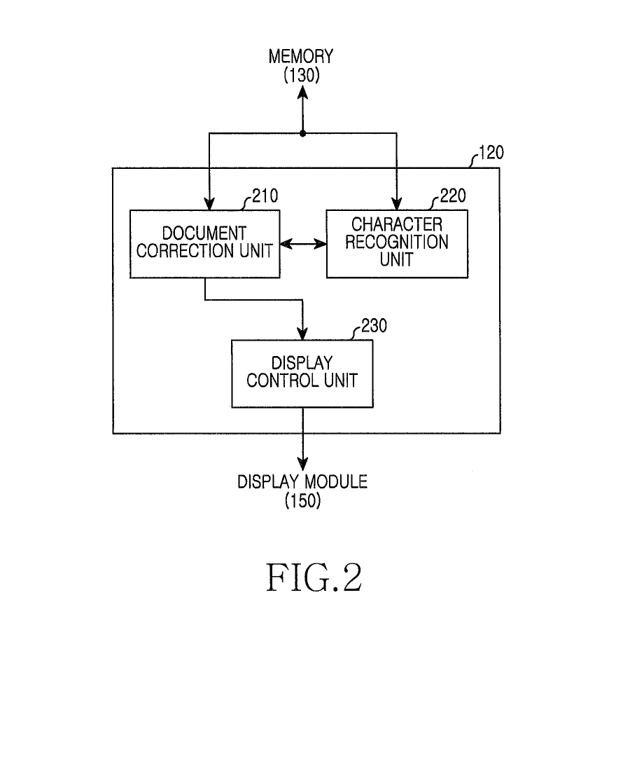

The processor 120 receives instructions from the constituent elements included in the electronic device 100 through the bus 110, deciphers the received instructions, and executes operation or data processing according to the deciphered instructions. At this time, the processor 120 controls to execute at least one application stored in the memory 130 and provide service in accordance to the executed application. For example, to execute a document correction program 131, a character recognition program 132, and a display control program 133 and correct a document, the processor 120 is constructed as illustrated in FIG. 2.

Also, the processor 120 includes one or more application processors (APs) or one or more communication processors (CPs). Here, the AP and the CP can be included within the processor 120 or can be included within different IC packages, respectively. Also, the AP and the CP can be also included within one IC package. The AP drives an operating system or an application program, controls a plurality of hardware or software constituent elements connected to the AP, and performs processing and operation of various data including multimedia data. Here, the AP is implemented as a system on chip (SoC). Also, the CP performs at least part of a multimedia control function. Also, the CP performs terminal distinction and authentication within a communication network using a subscriber identity module (such as a SIM card). At this time, the CP provides services such as voice telephony, video telephony, a text message, or packet data to a user. Also, the CP controls data transmission/reception of the communication module 160. The AP or the CP can load to a volatile memory an instruction or data received from a non-volatile memory connected to each of the AP and the CP or at least one of other constituent elements, and process the loaded instruction or data. Also, the AP or the CP stores in the non-volatile memory data received from at least one of the other constituent elements or generated by at least one of the other constituent elements. The CP performs a function of managing a data link and converting a communication protocol in a communication between an electronic device including hardware and other electronic devices connected through a network 162. Here, the CP can be implemented as a SoC. Additionally, the processor 120 can also include a graphic processing unit (GPU).

The memory 130 stores an instruction or data which is received from the processor 120 or the other constituent elements (such as the user input module 140, the display module 150, the communication module 160, and the camera or is generated by the processor 120 or the other constituent elements. The memory 130 can include an internal buffer and an external buffer. For example, the memory 130 stores images taken through the camera. The memory 130 also stores images captured during video playback. The memory 130 further stores a character original database capable of determining if a character is in a normal direction.

Also, the memory 130 includes the document correction program 131, the character recognition program 132, and the display control program 133. Each application is composed of a programming module, and each programming module can be composed of software, firmware, hardware, or a combination thereof.

The document correction program 131 includes at least one software constituent element for deciding a document of a normal direction. For example, if a document display event takes place, the document correction program 131 requests the character recognition program 132 to determine if at least one character exists in the document. If the character exists, the document correction program 131 corrects a slope of the document using a slope of the character. After that, the document correction program 131 determines if the character is in the normal direction using a character original database stored in the memory 130. If the character is not in the normal direction, the document correction program 131 rotates the document by a reference angle in a reference direction and determines if the direction of the character is the normal direction. By repeatedly performing this process, the document correction program 131 can decide the document of the normal direction. Additionally, the document correction program 131 also invert the document left/right or up/down and repeatedly perform the above process, thus deciding the document of the normal direction.

Also, the document correction program 131 includes at least one software constituent element for deciding an edge of a document. For example, the document correction program 131 recognizes at least one character existing outermost in each of the up/down/left/right directions of the document and joins an upper extension line including a character existing at the upside, a lower extension line including a character existing at the downside, a left extension line including a character existing at the left side, and a right extension line including a character existing at the right side, thus deciding the edge of the document.

The character recognition program 132 includes at least one software constituent element for recognizing a character included in a document. For example, in response to a request of the document correction program 131, the character recognition program 132 determines if the character is included in the document.

The display control program 133 includes at least one software constituent element for controlling to display at least one content through the display module 150. For example, the display control program 133 controls to display at least one document through the display module 150. The display control program 133 also controls to magnify and display at least one document through the display module 150.

Also, the memory 130 can include an internal memory or an external memory. The internal memory can include at least one of a volatile memory (such as a Dynamic Random Access Memory (DRAM), a Static Random Access Memory (SRAM), and a Synchronous Dynamic Random Access Memory (SDRAM)) or a non-volatile memory (such as a One Time PROM (OTPROM), a Programmable ROM (PROM), an Erasable Programmable ROM (EPROM), an Electrically Erasable Programmable ROM (EEPROM), a mask Read Only Memory (ROM), a flash ROM, a Not AND (NAND) flash memory, and a Not OR (NOR) flash memory). The internal memory can also take a form of Solid State Drive (SSD). The external memory can include at least one of Compact Flash (CF), Secure Digital (SD), Micro Secure Digital (Micro-SD), Mini Secure Digital (Mini-SD), extreme Digital (xD), and a memory stick.

Also, the memory 130 can further include a kernel, a middleware, and an Application Programming Interface (API). The kernel controls or manages system resources (such as the bus 110, the processor 120, or the memory 130) used for executing operations or functions implemented in the remnant other programming modules (such as the middleware, the API, or the application). Also, the kernel provides an interface of enabling the middleware, the API, or the application to access and controls or manages the individual constituent element of the electronic device 100. The middleware performs a relay role of enabling the API or the application to communicate and exchange data with the kernel. Also, the middleware performs load balancing for the work request using a method of allotting the order of priority capable of using the system resources (such as the bus 110, the processor 120, or the memory 130) of the electronic device 100 to work requests received from at least one application. The API is an interface of enabling the application to control a function provided by the kernel or the middleware. The API can include at least one interface or function for file control, window control, image processing, or character control.

The user input module 140 receives an input of an instruction or data from a user and forwards the instruction or data to the processor 120 or the memory 130 through the bus 110. For example, the user input module 140 includes a touch panel, a pen sensor, a key, or an ultrasonic input device. The touch panel recognizes a touch input in at least one method among a capacitive method, a pressure sensitive method, an infrared method, and an ultrasonic method. Also, the touch panel further includes a controller. In the capacitive method, not only direct touch but also proximity recognition is possible. The touch panel further includes a tactile layer. In an embodiment, the touch panel provides a tactile response to a user. For example, the pen sensor is implemented using the same or similar method with receiving a user's touch input or a separate sheet for recognition. The key includes a keypad or a touch key. The ultrasonic input device, which is a device capable of confirming data by sensing a sound wave with a microphone in the electronic device, performs wireless recognition through a pen generating an ultrasonic signal.

The display module 150 can display an image, a video, or data to the user. The display module 150 includes a panel or a hologram. For example, the panel can be a Liquid Crystal Display (LCD) or an Active-Matrix Organic Light-Emitting Diode (AMOLED). Also, the panel can be implemented to be flexible, transparent, or wearable. The panel is constructed as one module together with the touch panel. The hologram shows a three-dimensional image in the air by using interference of light. Additionally, the display module 150 includes a control circuit for controlling the panel or the hologram.

Also, the display module 150 displays data in accordance to the control of the display control application 133. The display module 150 displays at least one document. The display module 150 also magnifies and displays at least one document.

The communication module 160 connects communication between the electronic device 100 and other electronic devices 102 and 104. At this time, the communication module 160 supports a short-range communication protocol (such as wireless fidelity (WiFi), Bluetooth (BT), or near field communication (NFC)), and a network communication 162 (such as the Internet, a local area network (LAN), a wide area network (WAN), a telecommunication network, a cellular network, a satellite network, or a plain old telephone system (POTS)).

The camera acquires a subject through an image sensor.

An image processing unit, an image signal processor (ISP), converts output data (such as raw data) from the camera into image frame (RGB/YUV) data having a format of a predefined rule and provides the converted data to the processor 120. The image processing unit can be included in the camera. Also, the image processing unit can be included in the processor 120.

Other electronic devices 102 and 104 each can be the same (such as same-type) device as the electronic device 100 or can be a different (such as different-type) device.

Additionally, the electronic device 100 can further include a sensor module. The sensor module includes at least one of a gesture sensor, a gyro sensor, an air pressure sensor, a magnetic sensor, an acceleration sensor, a grip sensor, a proximity sensor, a red green blue (RGB) sensor, a biological sensor, a temperature/humidity sensor, a light sensor, and a ultraviolet (UV) sensor. Also, the sensor module measures a physical quantity or senses an activation state of the electronic device and converts the measured or sensed information into an electrical signal. For example, the sensor module can include an electronic nose (E-nose) sensor, an electromyography (EMG) sensor, an electroencephalogram (EEG) sensor, an electrocardiogram (ECG) sensor, or a fingerprint sensor. Also, the sensor module includes a control circuit for controlling at least one or more sensors provided therein.

The names of the aforementioned constituent elements of the hardware according to this disclosure can be varied according to the kind of the electronic device. The hardware according to this disclosure can include at least one of the aforementioned constituent elements, and can omit some constituent elements or further include additional other constituent elements. Also, some of the constituent elements of the hardware 200 according to the various exemplary embodiments of the present disclosure are coupled and constructed as one entity, thereby being able to identically perform the functions of the corresponding constituent elements of before being coupled.

FIG. 2 is a block diagram illustrating a detailed construction of an example processor according to this disclosure.

As illustrated in FIG. 2, the processor 120 includes a document correction unit 210, a character recognition unit 220, and a display control unit 230.

The document correction unit 210 controls to execute the document correction program 131 stored in the memory 130 and decide a document of a normal direction. For example, if a document display event takes place, the document correction unit 210 requests the character recognition unit 220 to determine if at least one character exists in the document. If the character exists, the document correction unit 210 corrects a slope of the document using a slope of the character. After that, the document correction unit 210 determines if the character is in the normal direction using a character original database stored in the memory 130. If the character is not in the normal direction, the document correction unit 210 rotates the document by a reference angle in a reference direction and determines if the direction of the character is the normal direction. By repeatedly performing this process, the document correction unit 210 can decide the document of the normal direction. Additionally, the document correction unit 210 also inverts the document left/right or up/down and repeatedly performs the above process, thus deciding the document of the normal direction.

Also, the document correction unit 210 controls to decide an edge of a document. For example, the document correction unit 210 recognizes at least one character existing outermost in each of the up/down/left/right directions of the document and joins an upper extension line including a character existing at the upside, a lower extension line including a character existing at the downside, a left extension line including a character existing at the left side, and a right extension line including a character existing at the right side, thus deciding the edge of the document.

The character recognition unit 220 controls to execute the character recognition program 132 stored in the memory 130 and recognize a character included in a document. For example, in response to a request of the document correction unit 210, the character recognition unit 220 determines if the character is included in the document.

The display control unit 230 controls to execute the display control program 133 stored in the memory 130 and displays data through the display module 150. For example, the display control unit 230 controls to display at least one document through the display module 150. The display control unit 230 also controls to magnify and display at least one document through the display module 150.

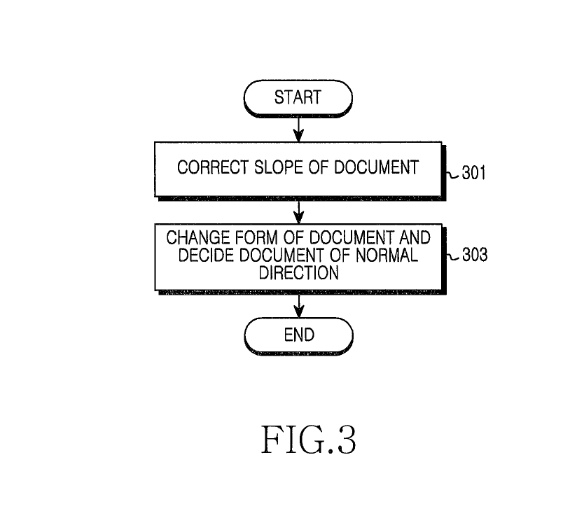

FIG. 3 is a flowchart illustrating an example procedure for deciding a document of a normal direction in an electronic device according to this disclosure.

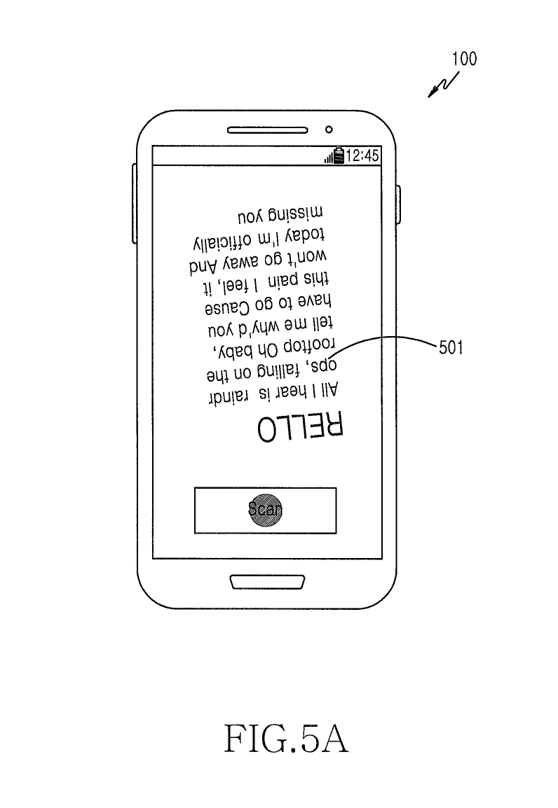

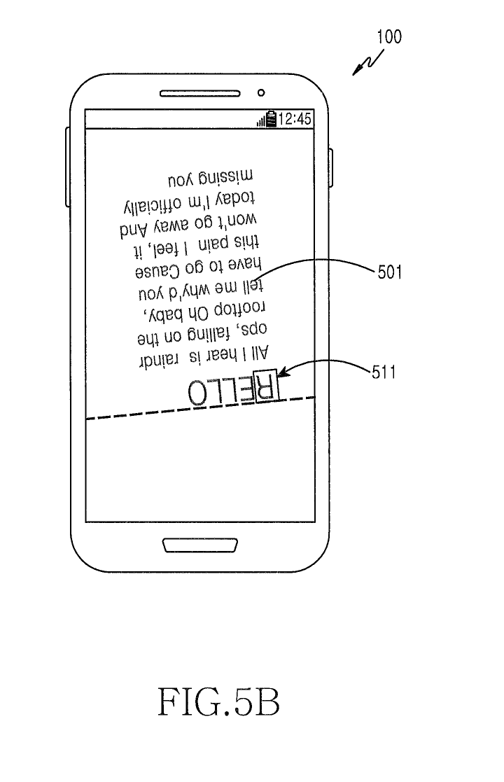

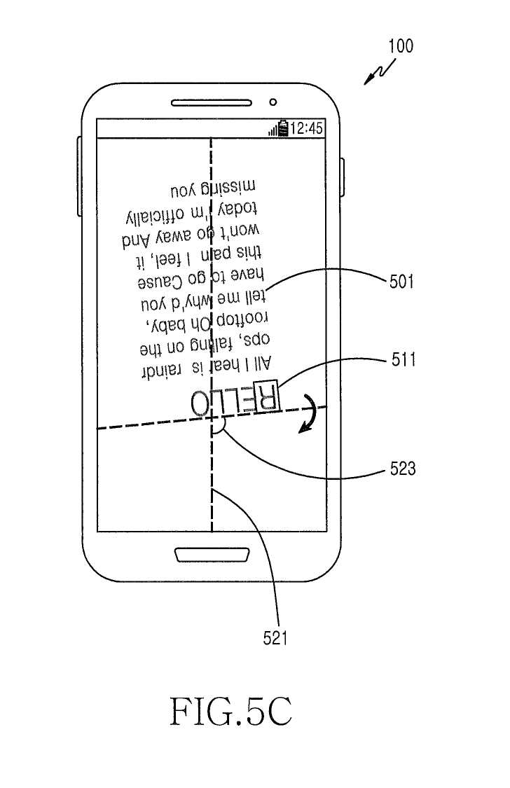

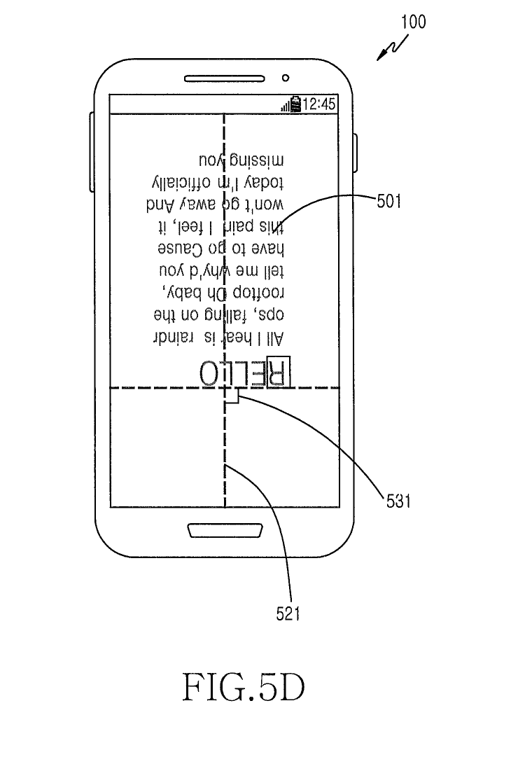

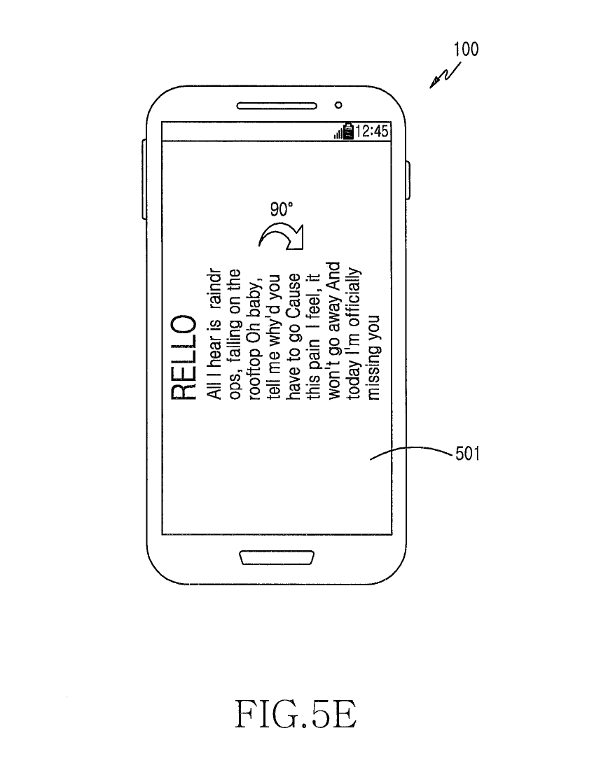

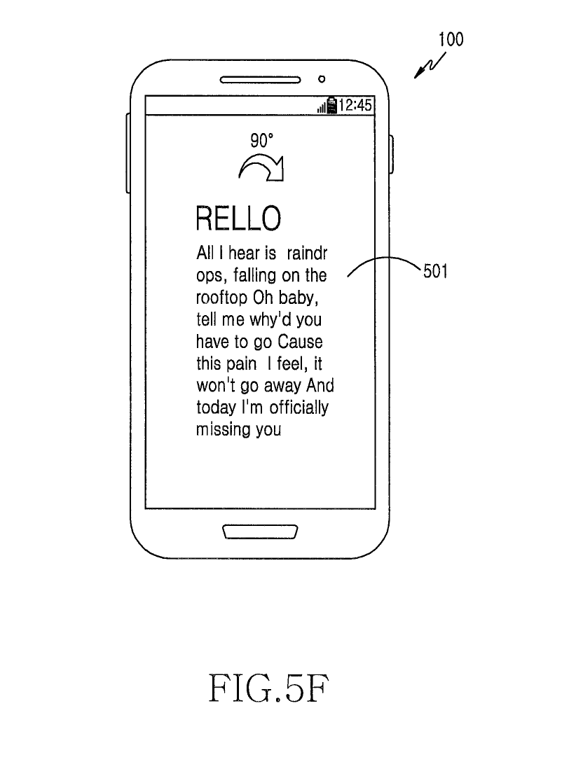

Referring to FIG. 3, in step 301, the electronic device corrects a slope of a document using at least one character included in the document. For example, if the electronic device captures an image (501) as illustrated in FIG. 5A and then senses a character “R” (511) as illustrated in FIG. 5B, the electronic device corrects a slope of the image (501) such that an angle (523) between the character “R” (511) and a virtual vertical line (521) illustrated in FIG. 5C become right angle (531) illustrated in FIG. SD. Here, the electronic device corrects the slope of the document such that the angle between the character and the vertical line become the right angle, but this does not intend to limit the scope and spirit of this disclosure.

In step 303, the electronic device changes a form of the document correcting the slope and decides the document of a normal direction. For instance, if it is recognized that the direction of the “R” (511) is not the normal direction as illustrated in FIG. 5D, the electronic device rotates the document by 90 degrees to the right as illustrated in FIG. 5E. After rotating the document, if it is recognized that the direction of the character is not the normal direction in the document illustrated in FIG. 5E, the electronic device again rotates the document by 90 degrees to the right as illustrated in FIG. 5F. Next, if it is recognized that the direction of the “R” (511) is the normal direction as illustrated in FIG. 5F, the electronic device recognizes that the image (501) of FIG. SF is the document of the normal direction.

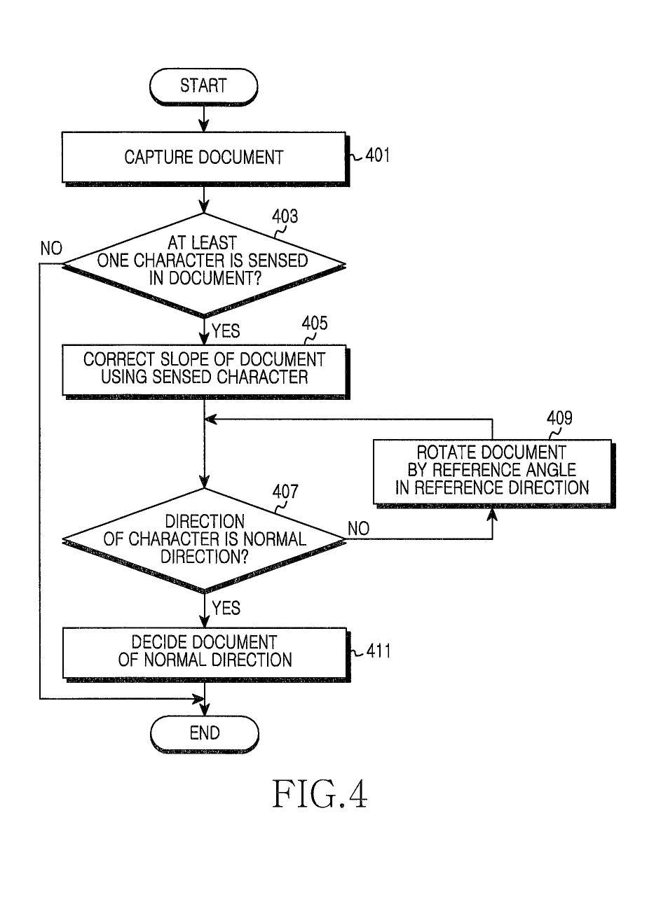

FIG. 4 is a flowchart illustrating an example procedure for deciding a document of a normal direction in an electronic device according to this disclosure.

Referring to FIG. 4, in step 401, the electronic device captures a document. For example, the electronic device can take at least one image through a camera. The electronic device can also open at least one image stored in the memory. The electronic device can also capture at least one frame included in a video.

After that, in step 403, the electronic device determines if at least one character is sensed in the document. For example, after capturing the document, the electronic device can sense at least one character based on a selection of a separate menu for sensing a character in the captured document. After capturing the document, the electronic device can also proceed to an operation of sensing at least one character without separate menu handling. If the at least one character is not sensed in the document, the electronic device can terminate the present algorithm.

Meantime, if the at least one character is sensed in the document, in step 405, the electronic device corrects a slope of the document using the sensed character. For example, if the electronic device captures an image (501) as illustrated in FIG. 5A and then senses a character “R” (511) as illustrated in FIG. 5B, the electronic device can correct a slope of the image (501) such that an angle (523) between the character “R” (511) and a virtual vertical line (521) illustrated in FIG. 5C become right angle (531) illustrated in FIG. 5D. Here, the electronic device corrects the slope of the document such that the angle between the character and the vertical line become the right angle, but this does not intend to limit the scope and spirit of this disclosure.

After correcting the slope of the document, in step 407, the electronic device determines if the direction of the character is a normal direction. For example, the electronic device can compare the character “R” (511) with a character original database stored in the memory and determine if the direction of the character “R” (511) is the normal direction.

If the direction of the character is not the normal direction, the electronic device proceeds to step 409 and rotates the document by a reference angle in a reference direction. For instance, if it is recognized that the direction of the “R” (511) is not the normal direction as illustrated in FIG. 5D, the electronic device rotates the document by 90 degrees to the right as illustrated in FIG. 5E. After rotating the document, in step 407, the electronic device again determines if the direction of the character is the normal direction. For instance, if it is recognized that the direction of the character is not the normal direction in the document illustrated in FIG. 5E, the electronic device can again rotate the document by 90 degrees to the right as illustrated in FIG. 5F.

Meantime, if the direction of the character is the normal direction, in step 411, the electronic device decides the document of the normal direction. Next, if it is recognized that the direction of the “R” (511) is the normal direction as illustrated in FIG. 5F, the electronic device recognizes that the image (501) of FIG. 5F is the document of the normal direction.

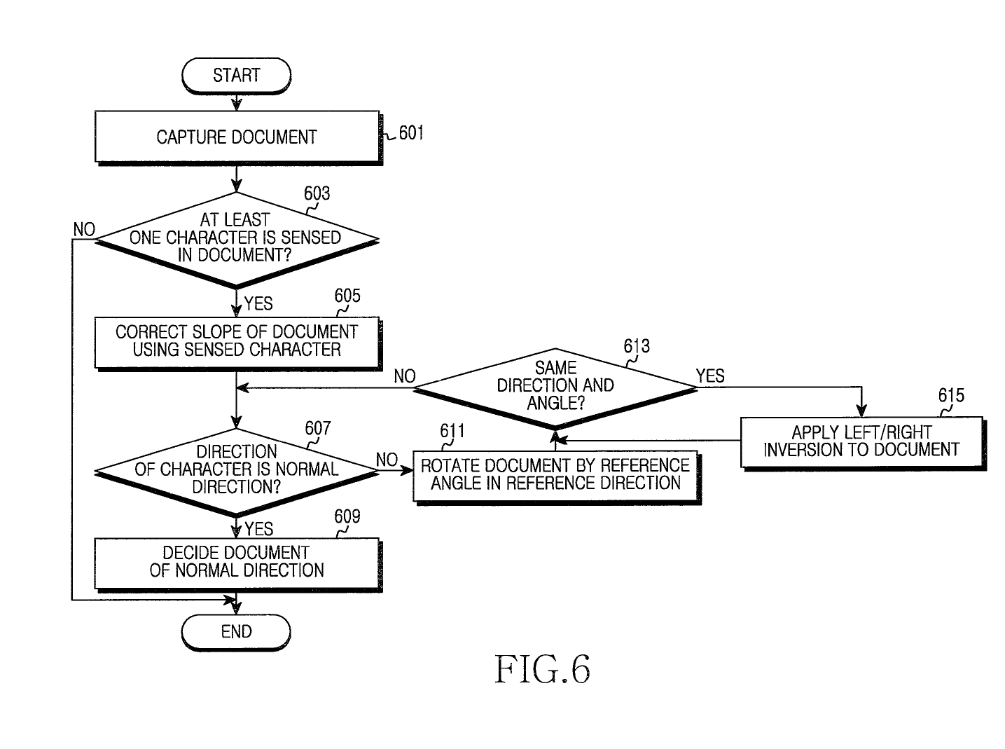

In an embodiment, the electronic device corrects the slope of the document. The electronic device can also decide the document of the normal direction without correcting the slope of the document. The electronic device can rotate the document by the reference direction and the reference angle and decide the document of the normal direction. The electronic device can also rotate the document by the reference direction and the reference angle and additionally apply the left/right inversion of the document, thus deciding the document of the normal direction as illustrated in FIG. 6 below.

FIG. 6 is a flowchart illustrating an example procedure for deciding a document of a normal direction in an electronic device according to various exemplary embodiments of the present disclosure.

Referring to FIG. 6, in step 601, the electronic device captures a document. For example, the electronic device can take at least one image through a camera. The electronic device can also open at least one image stored in the memory. The electronic device can also capture at least one frame included in a video.

After that, in step 603, the electronic device determines if at least one character is sensed in the document. For example, after capturing the document, the electronic device can sense at least one character based on a selection of a separate menu for sensing a character in the captured document. After capturing the document, the electronic device can also proceed to an operation of sensing at least one character without separate menu handling. If the at least one character is not sensed in the document, the electronic device can terminate the present algorithm.

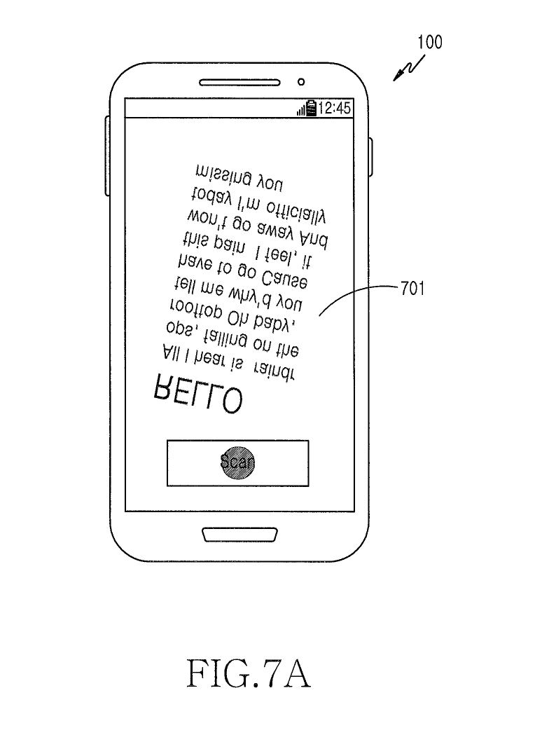

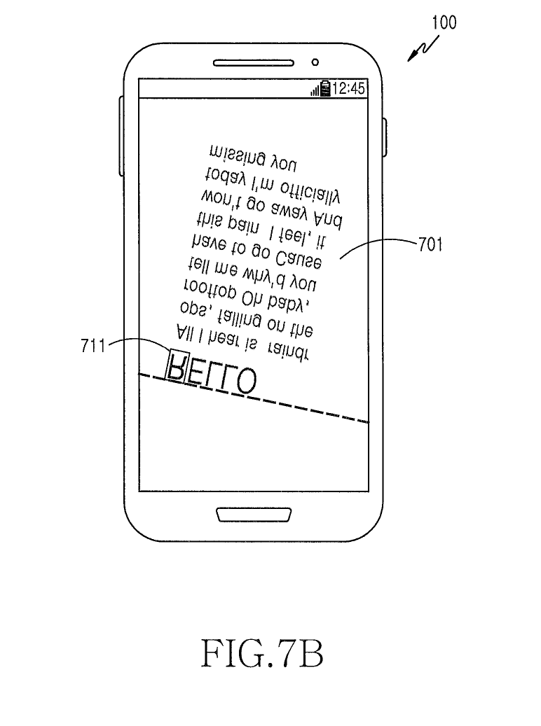

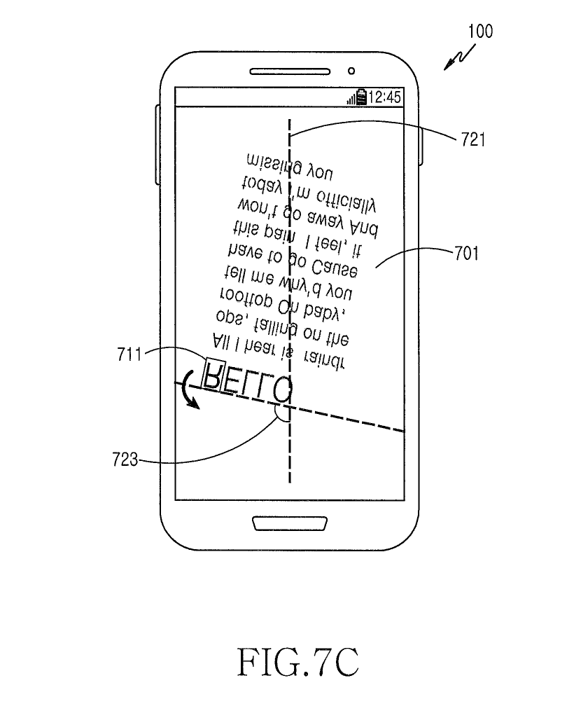

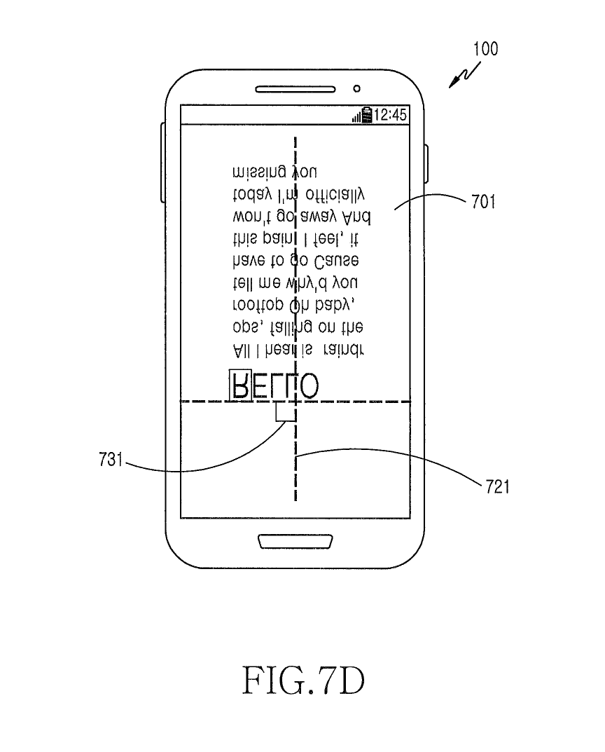

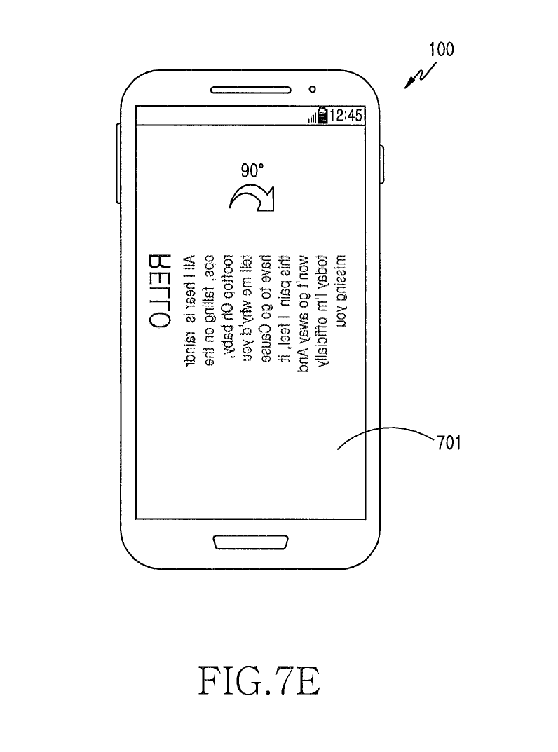

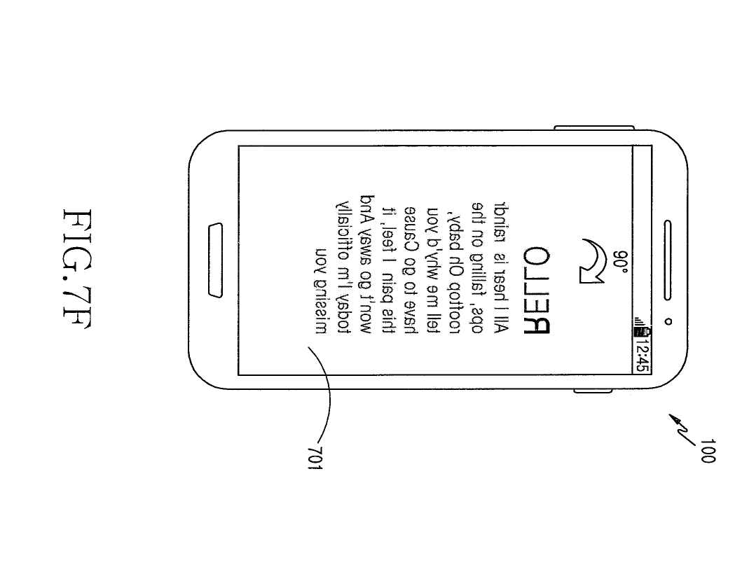

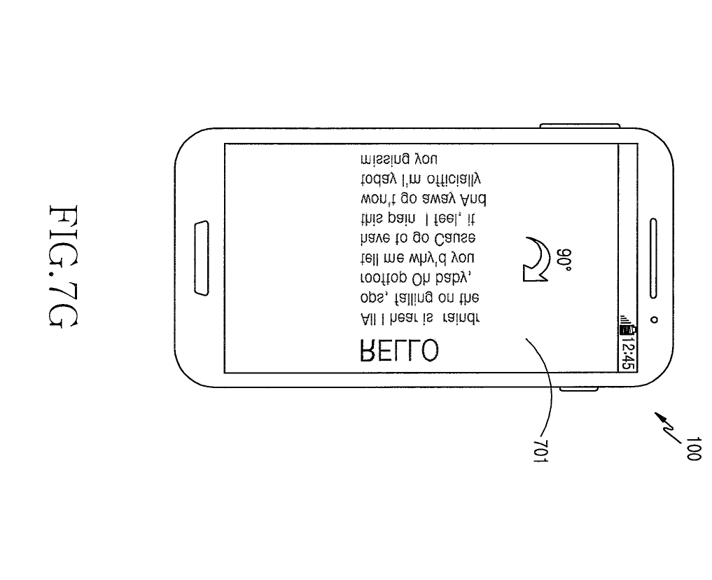

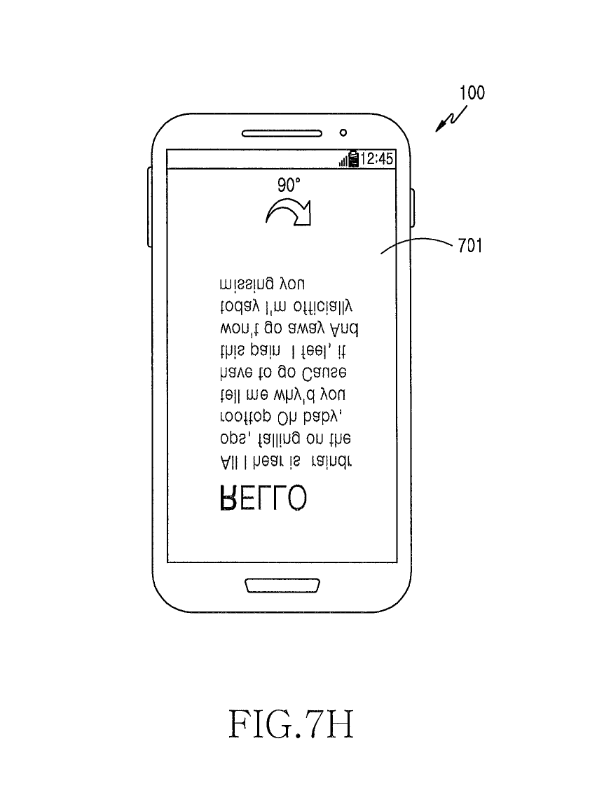

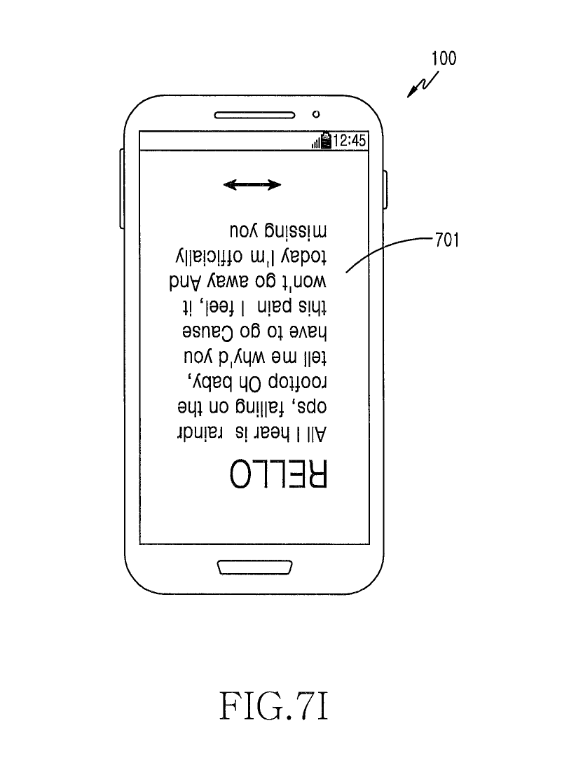

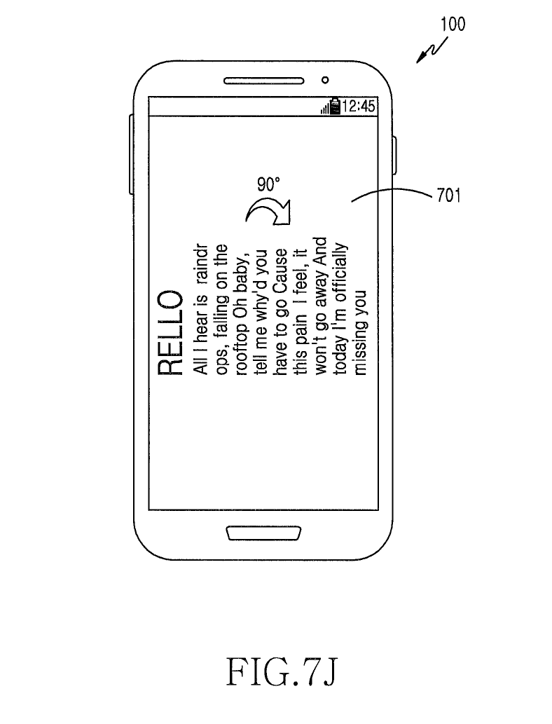

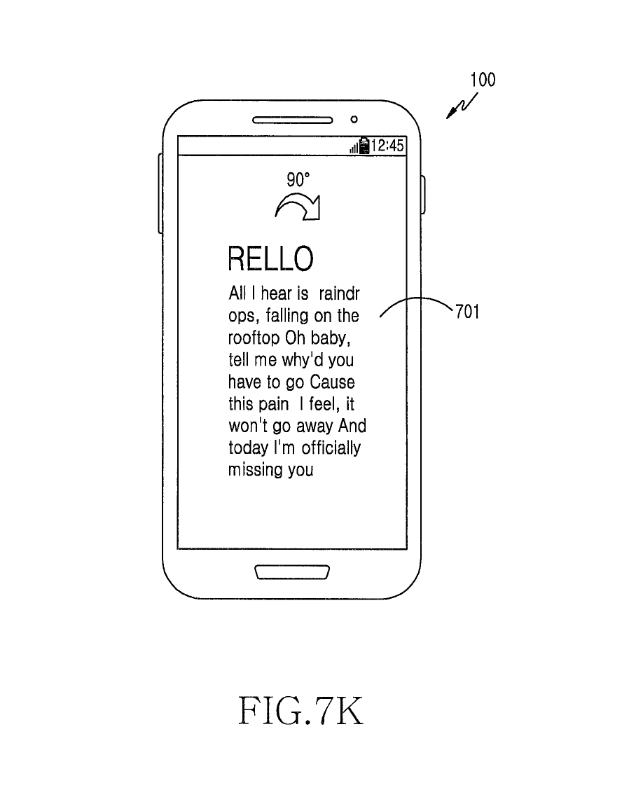

Meantime, if the at least one character is sensed in the document, in step 605, the electronic device corrects a slope of the document using the sensed character. For example, if the electronic device captures an image (701) as illustrated in FIG. 7A and then senses a character “R” (711) as illustrated in FIG. 7B, the electronic device can also correct a slope of the image (701) such that an angle (723) between the character “R” (711) and a virtual vertical line (721) illustrated in FIG. 7C become right angle (731) illustrated in FIG. 7D. Here, the electronic device corrects the slope of the document such that the angle between the character and the vertical line become the right angle, but this does not intend to limit the scope and spirit of this disclosure.

After correcting the slope of the document, in step 607, the electronic device determines if the direction of the character is a normal direction. For example, the electronic device can compare the character “R” (711) with a character original database stored in the memory and determine if the direction of the character “R” (711) is the normal direction.

If the direction of the character is not the normal direction, the electronic device proceeds to step 611 and rotates the document by a reference angle in a reference direction. For instance, if it is recognized that the direction of the “R” (711) is not the normal direction as illustrated in FIG. 7D, the electronic device rotates the document by 90 degrees to the right as illustrated in FIG. 7E.

After rotating the document by the reference angle in the reference direction, in step 613, the electronic device determines if the rotated document is a document of a same direction and angle. If the rotated document is not the document of the same direction and angle, the electronic device returns to step 607 and again determines if the direction of the character is the normal direction. For instance, if it is recognized that the direction of the character is not the normal direction in the document illustrated in FIG. 7E, the electronic device can again rotate the document by 90 degrees to the right as illustrated in FIG. 7F. If it is recognized that the direction of the character is not the normal direction in the document illustrated in FIG. 7F, the electronic device can also again rotate the document by 90 degrees to the right as illustrated in FIG. 7G. If it is recognized that the direction of the character is not the normal direction in the document illustrated in FIG. 7G, the electronic device can also again rotate the document by 90 degrees to the right as illustrated in FIG. 7H.

Meantime, if it is recognized that the rotated document is the document of the same direction and angle, in step 615, the electronic device applies left/right inversion to the document. For example, if the direction and angle of the document applying the rotation as illustrated in FIG. 7H are equal to the direction and angle of the document not applying the rotation as illustrated in FIG. 7D, the electronic device can recognize that there is not a case in which the direction of the character is the normal direction by rotating the document by the reference angle in the reference direction. The electronic device applies the left/right inversion to the document 701 as illustrated in FIG. 7I.

After that, the electronic device again performs step 613 and subsequent steps. For example, the electronic device determines if the left/right inverted document illustrated in FIG. 7I is in a direction and angle of an earlier determined document. If it is recognized that the left/right inverted document has never been determined earlier, the electronic device can rotate the document by 90 degrees to the right as illustrated in FIG. 7J. After that, if the document illustrated in FIG. 7J is not in the normal direction, the electronic device can also again rotate the document by 90 degrees to the right as illustrated in FIG. 7K.

Meantime, if the direction of the character is the normal direction, in step 609, the electronic device decides the document of the normal direction. For example, if it is recognized that the direction of the “R” (711) is the normal direction as illustrated in FIG. 7K, the electronic device can recognize that the image (701) of FIG. 7F is the document of the normal direction.

In an embodiment, the electronic device corrects the slope of the document. The electronic device can also decide the document of the normal direction without correcting the slope of the document. The electronic device can rotate the document by the reference angle in the reference direction and additionally applies the left/right inversion to the document, thus deciding the document of the normal direction. The electronic device can also rotate the document by the reference angle in the reference direction and apply the up/down inversion to the document, thus deciding the document of the normal direction. The electronic device can recognize at least one character included in the document and decide the document of the normal direction based on whether the recognized character is in the normal direction.

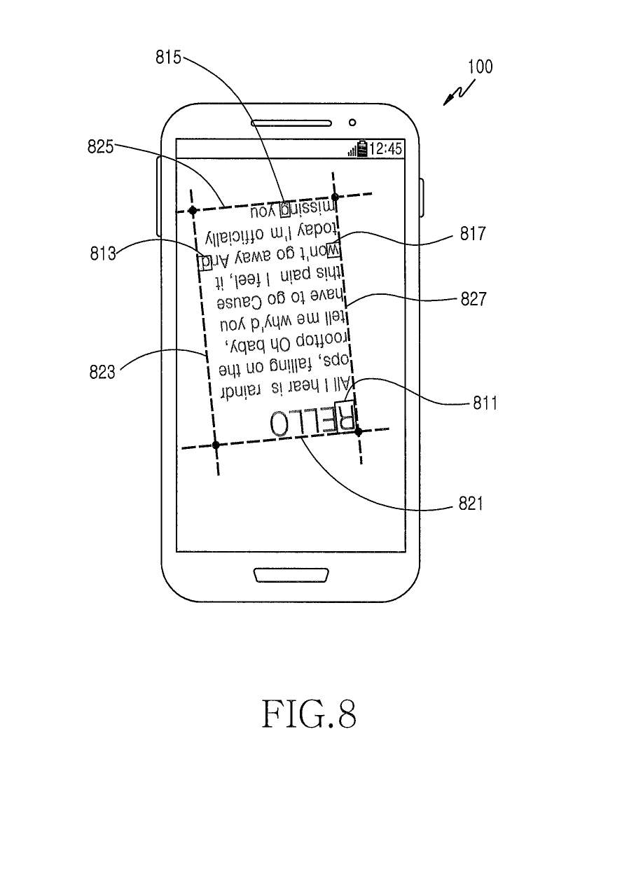

As illustrated in FIG. 8, the electronic device recognizes at least one character 811, 813, 815, or 817 existing outermost in each of the up/down/left/right directions of the document and joins an upper extension line 825 including a character 815 existing at the upside, a lower extension line 821 including a character 811 existing at the downside, a left extension line 823 including a character 813 existing at the left side, and a right extension line 827 including a character 817 existing at the right side, thus deciding the region (such as edge) of the document. After that, similar to FIG. 4 and FIG. 6, the electronic device corrects the slope of the decided document and rotates the document by the reference angle in the reference direction, thus deciding the document of the normal direction.

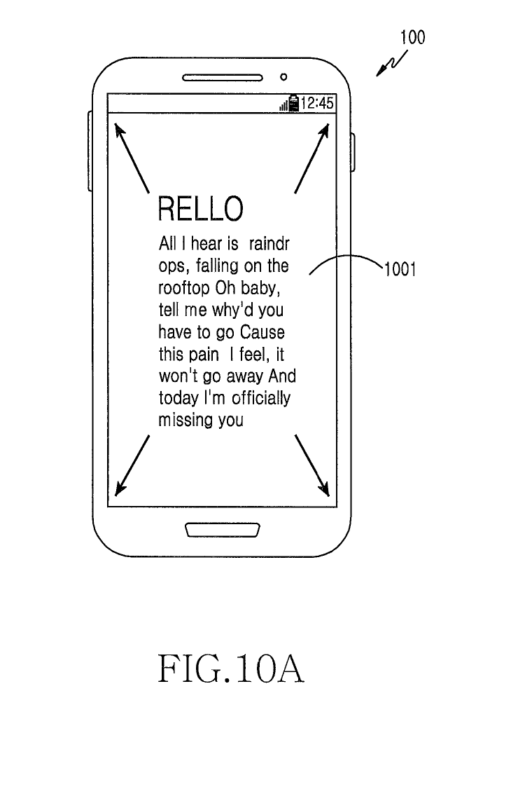

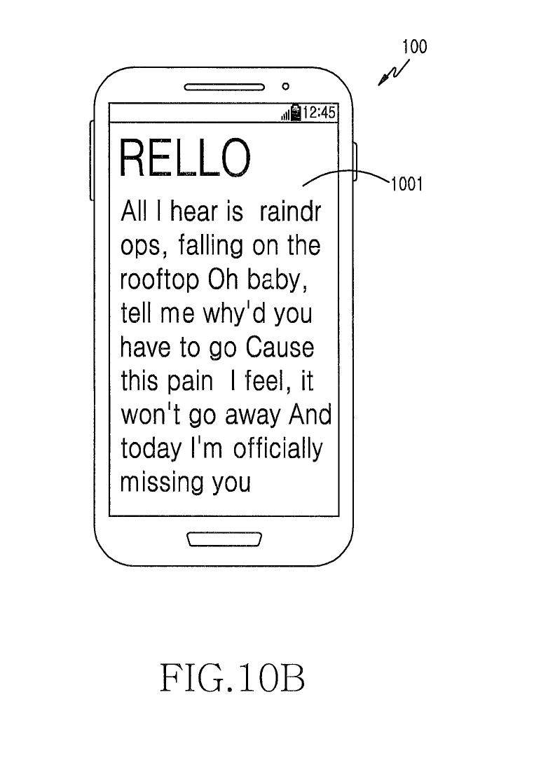

Also, after the electronic device decides a document (1001) of a normal direction as illustrated in FIG. 10A, the electronic device decides the document excluding a blank of the document (1001) as illustrated in FIG. 10B. In this case, the electronic device magnifies and displays the document as much as the region (such as edge) of the document decided in FIG. 8.

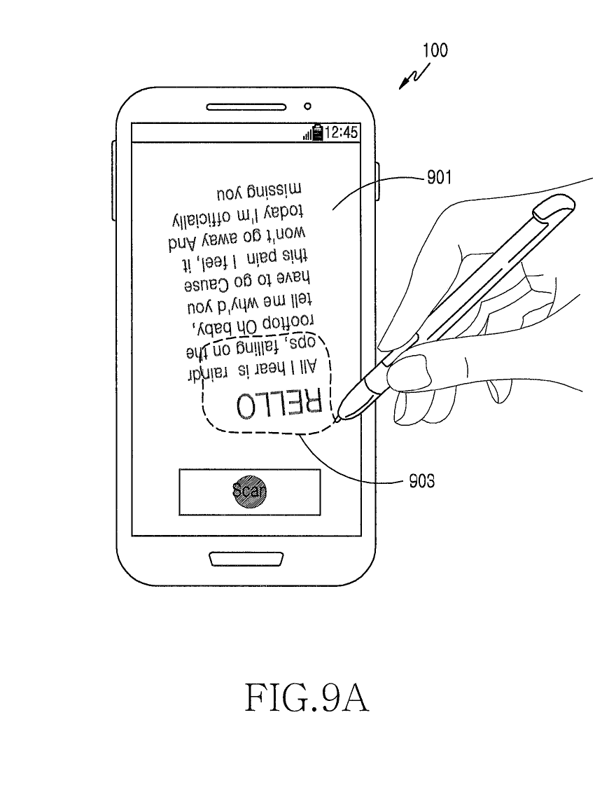

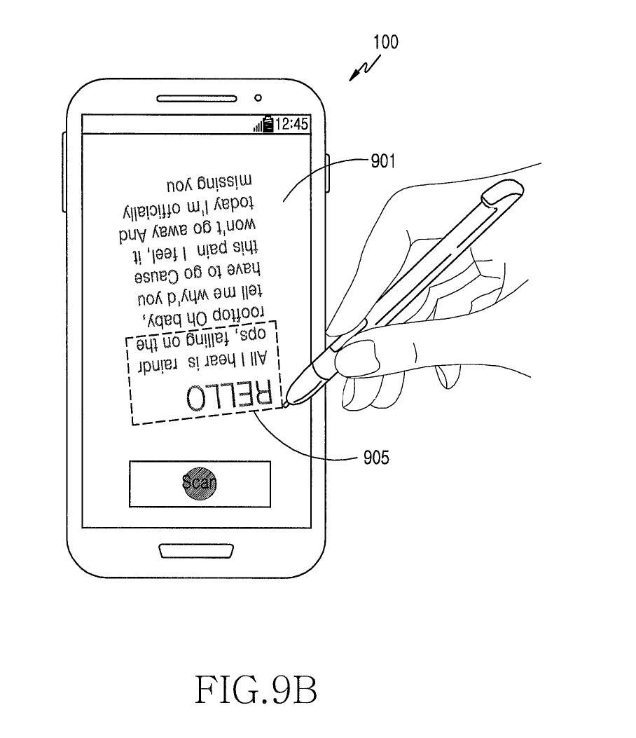

In an embodiment, the electronic device captures an image and decides a document of a normal direction for the captured image. The electronic device can also capture an image and decide a document of a normal direction for a partial edge of the captured image. For example, if a 1^{st} region 903 is decided by user's selection in a captured document 901 as illustrated in FIG. 9A, the electronic device can decide a 2^{nd} region 905 as illustrated in FIG. 9B such that the 2^{nd} region 905 includes all characters on an extension line of a left/right direction in the 1^{st} region 903 decided by the user's selection. After that, similar to FIG. 4 and FIG. 6, the electronic device corrects a slope of the 2^{nd} region 905 and rotates the 2^{nd} region 905 by a reference angle in a reference direction, thus deciding the 2^{nd} region 905 of the normal direction. That is, the electronic device can decide a separate document of a normal direction including the 2^{nd} region 905.

In an embodiment, the electronic device can also capture an image and decide a document of a normal direction using a character included in a partial edge of the captured image. For example, if a 1^{st} region 903 is decided by user's selection in a captured document 901 as illustrated in FIG. 9A, the electronic device can decide a 2^{nd} region 905 as illustrated in FIG. 9B such that the 2^{nd} region 905 includes all characters on an extension line of a left/right direction in the 1^{st} region 903 decided by the user's selection. After that, similar to FIG. 4 and FIG. 6, the electronic device can correct a slope of the document using at least one character included in the 2^{nd} region 905 and rotate the document by a reference angle in a reference direction, thus deciding the document of the normal direction.

As described above, there is an advantage that an electronic device user can be provided with a document of a normal direction without separate handling, by recognizing a character included in the document and deciding the document of the normal direction in an electronic device.

While the disclosure has been shown and described with reference to certain preferred embodiments thereof, it will be understood by those skilled in the art that various changes in form and details may be made therein without departing from the spirit and scope of this disclosure as defined by the appended claims.

What is claimed is:

1. A method in an electronic device, the method comprising:
correcting a second slope of a document based on a first slope of at least one character located in the document; and
changing a form of the document of which the second slope is corrected and deciding the document of a normal direction.

2. The method of claim 1, wherein correcting the second slope of the document comprises correcting the second slope of the document based on an average slope of a plurality of characters located in the document.

3. The method of claim 1, wherein correcting the second slope of the document comprises correcting the second slope of the document based on a slope of the largest number among slopes of a plurality of characters located in the document.

4. The method of claim 1, wherein changing the form of the document and deciding the document of the normal direction comprises:
determining whether the character is in the normal direction; and
if the character is in the normal direction, deciding the document as the document of the normal direction.

5. The method of claim 4, wherein determining whether the character is in the normal direction comprises determining whether the character is in the normal direction based on comparison between a character original database including character information of the normal direction and the character.

6. The method of claim 1, wherein changing the form of the document and deciding the document of the normal direction comprises rotating the document by a reference angle in a reference direction.

7. The method of claim 1, wherein changing the form of the document and deciding the document of the normal direction comprises inverting the document left, right, up, or down.

8. The method of claim 1, further comprising determining an edge of the document using a plurality of characters located in the document.

9. The method of claim 1, further comprising determining an edge of the document based on region setting for the document.

10. The method of claim 9, further comprising when a non-comprised text exits at the left or right of the region, resetting the region to include the non-comprised text.

11. The method of claim 1, further comprising magnifying and displaying the document to include all of the content of the decided document.

12. An electronic device comprising:
a memory;
a display; and
at least one processor configured to control to correct a second slope of a document based on a first slope of at least one character comprised in the document, change a form of the document of which the slope is corrected, and decide the document of a normal direction.

13. The device of claim 12, wherein, the processor is configured to correct the slope of the document based on an average slope of a plurality of characters included in the document.

14. The device of claim 12, wherein, the processor is configured to correct the slope of the document based on a slope of the largest number among slopes of a plurality of characters included in the document.

15. The device of claim 12, wherein, the processor is configured to determine whether the character is in the normal direction; and
if the character is in the normal direction, decide the document as the document of the normal direction.

16. The device of claim 15, wherein, the processor is configured to determine whether the character is in the normal direction based on comparison between a character original database including character information of the normal direction and the character.

17. The device of claim 12, wherein, the processor is configured to rotate the document by a reference angle in a reference direction.

18. The device of claim 12, wherein, the processor is configured to invert the document left, right, up, or down.

19. The device of claim 12, wherein, the processor is configured to determine an edge of the document based on a plurality of characters included in the document.

20. The device of claim 12, wherein, the processor is configured to determine an edge of the document based on region setting for the document.

21. The device of claim 20, wherein, when a non-comprised text exits at the left or right of the region, the processor is configured to reset the region to include the non-comprised text.

22. The device of claim 12, wherein the processor is configured to control to magnify and display the document on the display to include all of the content of the decided document and display the document on the display.
